(19) United States
(12) Patent Application Publication
(10) Pub. No.: US 2026/0032470 A1
(43) Pub. Date: Jan. 29, 2026

(54) FLEXIBLE CONFIGURATION FOR BEAM FAILURE RECOVERY BASED ON USER EQUIPMENT RADIO CONDITION INFORMATION

(71) Applicant: QUALCOMM Incorporated, San Diego, CA (US)

(72) Inventors: Sitaramanjaneyulu KANAMARLAPUDI, San Diego, CA (US); Gavin Bernard HORN, La Jolla, CA (US); Linhai HE, San Diego, CA (US)

(21) Appl. No.: 18/783,193

(22) Filed: Jul. 24, 2024

(51) Int. Cl. H04W 24/04

(52) U.S. Cl. CPC H04W 24/04

(57) ABSTRACT

Systems and techniques are provided for wireless communications. For example, a process can include receiving configuration information corresponding to beam failure recovery (BFR) by a user equipment (UE), the configuration information indicative of one or more BFR configuration parameters selectable by the UE. The process can include determining, based on radio condition information associated with the UE, a selected value for each respective BFR configuration parameter of the one or more BFR configuration parameters selectable by the UE. The process can include performing BFR for one or more reference signal beams, based on the configuration information and using the selected value for each respective BFR configuration parameter of the one or more BFR configuration parameters selectable by the UE.

### FIELD

Aspects of the present disclosure generally relate to wireless communication. In some implementations, examples are described for beam failure recovery (BFR) performed by a user equipment (UE) using one or more BFR configuration parameter values determined by the UE.

### BACKGROUND

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some cases, a UE can be configured to perform beam failure detection (BFD) and beam failure recovery (BFR) for beamformed communications between the UE and a network entity (e.g., base station, gNB, etc.). For example, an active beam utilized by the UE for communications to or from the network entity can experience a beam failure event. A beam failure may be based on UE mobility or movement relative to the base station, beam reconfiguration at the base station, among various other factors. BFD can be performed by the UE to detect the beam failure event and/or to detect the occurrence of the beam failure event. BFR can be performed by the UE to recover to a new beam selected from a plurality of candidate beams associated with and/or configured for the BFR. In some cases, a beam failure can correspond to a signal quality of a beam (e.g., a reference signal received power (RSRP) value measured by the UE for a monitored beam and/or reference signal (RS)) falling below a configured threshold value. For example, the UE can determine a beam failure based on detecting one or more instances or occasions where the measured RSRP of a beam is less than or equal to a configured RSRP threshold value for beam failure detection. In some examples, a UE can be configured to perform beam failure recovery (BFR) based on a beam failure detection. For example, when a beam failure is detected, the UE can initiate a beam failure instance and may initialize a beam failure recovery timer and a beam failure instance counter. While the beam failure recovery counter is running, the UE can perform candidate beam identification to search for a candidate beam to recover the link with the network entity. The UE may measure the quality (e.g., RSRP) of each candidate beam of a plurality of candidate beams, and may determine a selected candidate beam for the recovery, based on the quality or RSRP measurements.

In some cases, the UE may perform the BFR based on BFR configuration information transmitted from a network entity to the UE. The use of BFR configuration information to indicate the details and parameters of the BFR procedure to be used by a UE can correspond to consistent BFR behavior across multiple UEs, but may also correspond to decreased flexibility in bandwidth part (BWP) switching for UEs experiencing a beam failure and/or while performing beam failure recovery. A UE receiving BFR configuration information may be required to perform the BFR procedure using the configured values indicated by the BFR configuration information. For example, a UE receiving BFR configuration information may be prevented from implementing an early or delayed BFR, including in scenarios where the UE may be associated with network traffic of a type or characteristic(s) that would more optimally be served by the early or delayed BFR initiation. In some cases, the strict implementation of UE-side BFR according to the BFR configuration information provided to the UE by the network (e.g., network entity, base station, gNB, etc.) may correspond to the UE being unable to adapt or modify the BFR procedure to better correspond to the network traffic and/or radio conditions that are being experienced by the UE. There is a need for systems and techniques that can be used for UEs to implement an autonomous or semi-autonomous BFR procedure where at least a portion of the BFR configuration parameters are determined by the UE and are not signaled or configured for the UE by the network entity (e.g., base station, gNB, etc.). For example, there is a need for systems and techniques that can be used for a UE to perform flexible beam failure recovery, where some (or all) of the BFR configuration parameters, triggers, thresholds, timer durations, etc., are determined by the UE and/or selected by the UE from within a range of values indicated by the network.

Systems, apparatuses, processes (also referred to as methods), and computer-readable media (collectively referred to as “systems and techniques”) are described herein that can be used to implement BFR for a UE, based on one or more BFR configurations and/or BFR parameters determined by the UE. For example, the systems and techniques can be used to implement flexible BFR procedures for a UE, based on the UE selecting or determining a BFR configuration based on a traffic type, one or more traffic characteristics, and/or local radio conditions observed or determined by the UE. In some aspects, the UE can select or determine the BFR configuration as one or more selections from a range of values or configuration options that are signaled or indicated to the UE by a network entity (e.g., base station, gNB, etc.). In some examples, the UE can select or determine the BFR configuration autonomously or semi-autonomously. For example, the UE may determine at least a portion of the BFR configuration for beam failure recovery by the UE without utilizing a BFR configuration or other information signaled to the UE by a network entity. In some cases, the UE may determine at least a portion of the BFR configuration for beam failure recovery without using information or configurations indicated to the UE by a network entity, and may determine an additional portion of the BFR configuration for beam failure recovery as a selection from a range of values or plurality of permitted options indicated to the UE by the network entity.

Disclosed are systems, methods, apparatuses, and computer-readable media for performing wireless communication. According to at least one illustrative example, a network device for wireless communication is provided. The network device includes at least one memory and at least one processor coupled to the at least one memory. The at least one processor is configured to: receive configuration information corresponding to beam failure recovery (BFR) by a user equipment (UE), wherein the configuration information is indicative of one or more BFR configuration parameters selectable by the UE; determine, based on radio condition information associated with the UE, a selected value for each respective BFR configuration parameter of the one or more BFR configuration parameters selectable by the UE; and perform BFR for one or more reference signal beams, wherein the BFR for the one or more reference signal beams is performed based on the configuration information and using the selected value for each respective BFR configuration parameter of the one or more BFR configuration parameters selectable by the UE.

In another example, a method for wireless communication is provided, the method including: receiving configuration information corresponding to beam failure recovery (BFR) by a user equipment (UE), wherein the configuration information is indicative of one or more BFR configuration parameters selectable by the UE; determining, based on radio condition information associated with the UE, a selected value for each respective BFR configuration parameter of the one or more BFR configuration parameters selectable by the UE; and performing BFR for one or more reference signal beams, wherein the BFR for the one or more reference signal beams is performed based on the configuration information and using the selected value for each respective BFR configuration parameter of the one or more BFR configuration parameters selectable by the UE.

In another example, a non-transitory computer-readable storage medium comprising instructions stored thereon which, when executed by at least one processor, causes the at least one processor to: receive configuration information corresponding to beam failure recovery (BFR) by a user equipment (UE), wherein the configuration information is indicative of one or more BFR configuration parameters selectable by the UE; determine, based on radio condition information associated with the UE, a selected value for each respective BFR configuration parameter of the one or more BFR configuration parameters selectable by the UE; and perform BFR for one or more reference signal beams, wherein the BFR for the one or more reference signal beams is performed based on the configuration information and using the selected value for each respective BFR configuration parameter of the one or more BFR configuration parameters selectable by the UE.

In another example, an apparatus is provided for wireless communication. The apparatus includes: means for receiving configuration information corresponding to beam failure recovery (BFR) by a user equipment (UE), wherein the configuration information is indicative of one or more BFR configuration parameters selectable by the UE; means for determining, based on radio condition information associated with the UE, a selected value for each respective BFR configuration parameter of the one or more BFR configuration parameters selectable by the UE; and means for performing BFR for one or more reference signal beams, wherein the BFR for the one or more reference signal beams is performed based on the configuration information and using the selected value for each respective BFR configuration parameter of the one or more BFR configuration parameters selectable by the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a diagram illustrating an example of a base station in communication with a UE using one or more beams, in accordance with some examples;

FIG. 7 is a diagram illustrating an example random access channel (RACH)-based beam failure recovery (BFR) procedure, in accordance with some examples;

FIG. 8 is a flow diagram illustrating example processes for wireless communication, in accordance with some examples;

FIG. 9 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

A UE may receive a beamformed signal from a base station or gNB on one or more receive beams. The UE may also transmit a beamformed signal to the base station on one or more beams. In some examples, the UE and the base station may determine the best beams for communicating with one another, based on selection from a plurality of available beams. For example, the UE and the base station may perform beam training to align the transmit and receive beams associated with beamformed communications between the UE and the base station. In some examples, an active and/or preferred beam utilized by the UE for communications to or from the base station can experience a beam failure event. For example, a beam failure may be based on UE mobility or movement relative to the base station, beam reconfiguration at the base station, among various other factors.

In some cases, a beam failure can correspond to a signal quality of a beam (e.g., measured by the UE) falling below a configured threshold value. For example, the UE can determine a beam failure based on detecting one or more instances or occasions where a reference signal received power (RSRP) is less than or equal to a configured RSRP threshold value for beam failure detection (BFD). In some examples, a UE can be configured to perform beam failure recovery (BFR) based on a beam failure detection.

A UE can perform BFD based on continuously or periodically monitoring the quality of an active beam that is being used by the UE for communication with a network entity (e.g., base station, gNB, etc.). Based on the beam quality deteriorating below a configured threshold value for a configured (e.g., predetermined) duration of time, the UE can detect a beam failure. Based on the UE detecting a beam failure, the UE may initiate a beam failure recovery process (e.g., BFR process). For example, when a beam failure is detected, the UE can initiate a beam failure instance and may initialize a beam failure recovery timer and a beam failure instance counter. While the beam failure recovery counter is running, the UE can perform candidate beam identification to search for a candidate beam to recover the link with the network entity. The UE may measure the quality (e.g., RSRP) of each candidate beam of a plurality of candidate beams, and may determine a selected candidate beam for the recovery, based on the quality or RSRP measurements.

In some examples, the BFR procedure performed by a UE can be configured based on one or more BFR configuration values signaled or indicated to the UE by the network entity (e.g., base station, gNB, etc.). For example, the UE can perform the BFR based on BFR configuration information transmitted from the network entity to the UE. The BFR configuration information can be indicative of one or more Beam Failure Detection (BFD) Reference Signals (BFD-RSs) that may be monitored by the UE to detect the beam failure. In some cases, the BFR configuration information can be indicative of one or more configured timer values or timer lengths, including a BFD timer (e.g., started when the UE detects a first beam failure instance (BFI) and begins incrementing a BFI counter) and/or a BFR timer (e.g., started when the UE transmits a Beam Failure Recovery Request (BFRQ) in response to the BFI counter exceeding a configured value before the BFD timer expires, and indicative of a maximum elapsed time for the UE to receive a Beam Failure Recovery Response (BFRR) after sending the BFRQ). In some examples, the BFR configuration information can be indicative of a threshold or maximum value for the BFI counter, where the UE is configured to trigger a BFR based on the BFI counter being equal to or exceeding the configured threshold value for the BFI counter within the duration of the BFD timer. In some examples, the BFR configuration information can be indicative of one or more RACH resources for performing the beam failure recovery by the UE. In some cases, the BFR configuration information can be signaled from the base station to the UE as beamFailureRecoveryConfig information.

The use of BFR configuration information (e.g., such as beamFailureRecoveryConfig information) to specify the details and parameters of the BFR procedure to be used by a UE can correspond to consistent BFR behavior across multiple UEs, but may also correspond to decreased flexibility in bandwidth part (BWP) switching for UEs experiencing a beam failure and/or while performing beam failure recovery. A UE receiving BFR configuration information may be required to perform the BFR procedure using the configured values indicated by the BFR configuration information. For example, a UE receiving BFR configuration information may be prevented from implementing an early or delayed BFR (e.g., at a BFI counter value less than the configured maximum BFI count to trigger BFR, or at a BFI counter value greater than the configured maximum BFI count to trigger BFR, respectively), including in examples where the UE may be associated with network traffic of a type or characteristic(s) that would more optimally be served by the early or delayed BFR initiation. In some cases, the strict implementation of UE-side BFR according to the BFR configuration information provided to the UE by the network (e.g., network entity, base station, gNB, etc.) may correspond to the UE being unable to adapt or modify the BFR procedure to better correspond to the network traffic and/or radio conditions that are being experienced by the UE.

There is a need for systems and techniques that can be used for UEs to implement an autonomous or semi-autonomous BFR procedure where at least a portion of the BFR configuration parameters are determined by the UE and are not signaled or configured for the UE by the network entity (e.g., base station, gNB, etc.). For example, there is a need for systems and techniques that can be used for a UE to perform flexible beam failure recovery, where some (or all) of the BFR configuration parameters, triggers, thresholds, timer durations, etc., are determined by the UE and/or selected by the UE from within a range of values indicated by the network.

Systems, apparatuses, processes (also referred to as methods), and computer-readable media (collectively referred to as “systems and techniques”) are described herein that can be used to implement BFR for a UE, based on one or more BFR configurations and/or BFR parameters determined by the UE. For example, the systems and techniques can be used to implement flexible BFR procedures for a UE, based on the UE selecting or determining a BFR configuration based on a traffic type, one or more traffic characteristics, and/or local radio conditions observed or determined by the UE. In some aspects, the UE can select or determine the BFR configuration as one or more selections from a range of values or configuration options that are signaled or indicated to the UE by a network entity (e.g., base station, gNB, etc.). In some examples, the UE can select or determine the BFR configuration autonomously or semi-autonomously. For example, the UE may determine at least a portion of the BFR configuration for beam failure recovery by the UE without utilizing a BFR configuration or other information signaled to the UE by a network entity. In some cases, the UE may determine at least a portion of the BFR configuration for beam failure recovery without using information or configurations indicated to the UE by a network entity, and may determine an additional portion of the BFR configuration for beam failure recovery as a selection from a range of values or plurality of permitted options indicated to the UE by the network entity.

In some aspects, a UE can receive information (e.g., transmitted or signaled to the UE by a network entity, etc.) indicative of a flexible BFR configuration where the UE is configured to determine some or all of the BFR parameters itself. For example, the UE can be configured to identify or determine the occurrence of a beam failure detection (BFD) event based on a UE-determined or UE-configured threshold number of beam failure instances (BFIs). In some cases, the UE can be configured to determine an RSRP threshold value for detecting the occurrence of a BFI. In some aspects, the UE can be configured to determine a BFD timer value corresponding to the time window within which a BFD is detected based on the BFI counter reaching the BFI maximum count threshold. In some cases, the UE can be configured to determine triggering conditions for initiating BFR. In some cases, the UE can be configured to determine a candidate beam selection and/or RACH procedure for performing BFR, and to subsequently utilize the UE-determine candidate beam selection and/or RACH procedure after initiating a BFR. Signaling from the UE to the network entity (e.g., base station, gNB, etc.) of the one or more UE-determined or UE selected BFR configuration parameters can be explicitly signaled, implicitly signaled, or indicated using a combination of explicit and implicit signaling between the UE and the network entity.

In some cases, the UE can implement one or more machine learning (ML) and/or artificial intelligence (AI) models that are trained to determine BFR configuration information and/or BFR parameter values that are optimized for the dynamic radio conditions, traffic patterns, etc., that are currently or recently experienced by the UE. In some aspects, the UE can utilize the one or more local ML or AI models implemented by the UE to determine dynamic BFR configuration information to initiate and/or perform a BFR. In some examples, the UE may utilize the one or more local ML or AI models to determine dynamic BFD parameters for detecting a beam failure event to trigger or initiate the BFR procedure.

In some examples, the UE can track and report BFR configuration information to the network entity. For example, the UE can report the one or more UE-determined BFR configuration parameters utilized by the UE for different BFR instances. In some cases, the UE-determined BFR configuration parameters can be reported in combination with a BFR result or BFR outcome corresponding to the BFR procedure that was performed by the UE utilizing a respective set of the UE-determined BFR configuration parameters. For example, the UE can indicate to the network entity a number of beam failures configured by the UE for detecting or declaring the BFD (e.g., in some cases, based on RSRP as an additional dimension). The UE may indicate to the network entity a time to find candidate beam selection and successful BFR, RACH resources utilized, an optimal RSRP threshold for finding or selecting a new candidate beam, etc. The information can be indicated by the UE to the network entity utilizing event-based reporting associated with a BFR performed by the UE. For example, in some cases, the UE can transmit a Beam Failure Recovery Request (BFRQ) indicative of a BFD and/or BFR, where the BFRQ is further indicative of (e.g., extended to include) information corresponding to the internal parameters and UE-determined BFR configuration information implemented during the BFR performed by the UE. In some cases, the UE can perform periodic and/or consolidated reporting indicative of the respective internal parameters and UE-determined BFR configuration information utilized by the UE for multiple previous BFRs performed by the UE. In some cases, the BFR configuration information and BFR report information transmitted by the UE can be used for AI/ML model training, re-training, finetuning, etc., by the network entity, the UE, and/or both the network entity and the UE.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. Abase station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

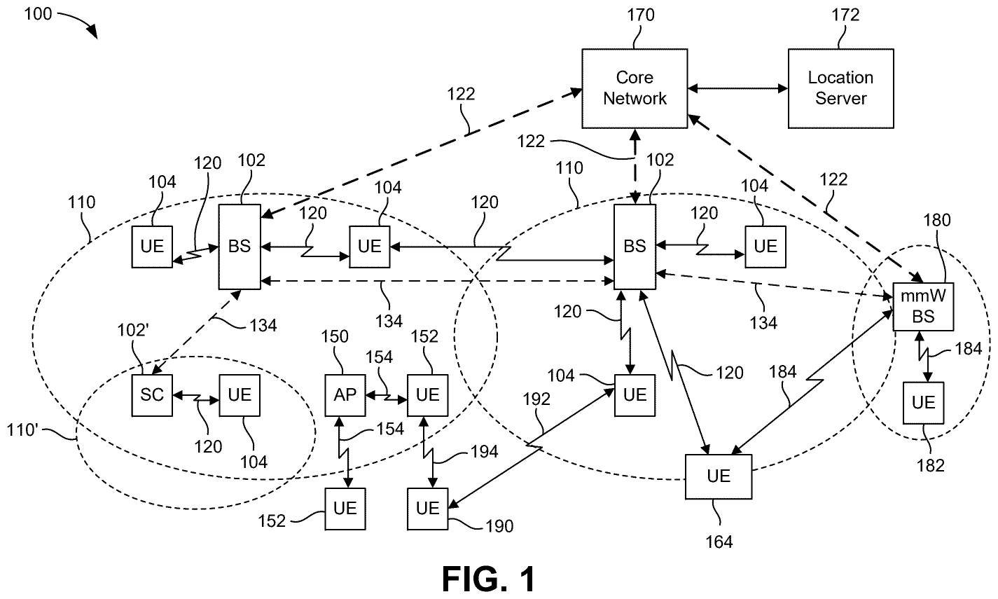

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHIz)), FR2 (e.g., from 24,250 to 52,600 MHIz), FR3 (e.g., above 52,600 MHIz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

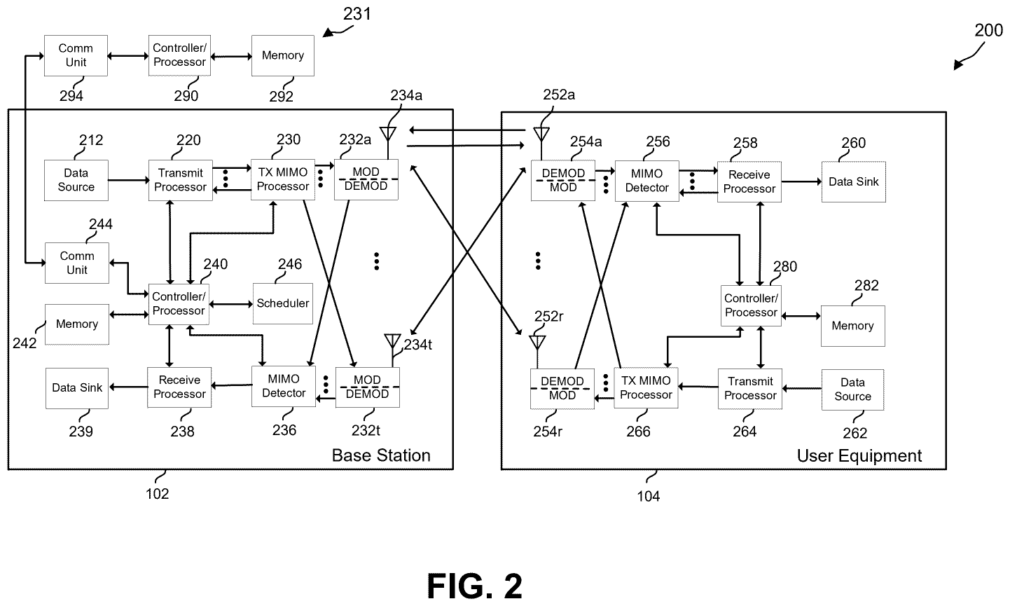

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, e.g., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

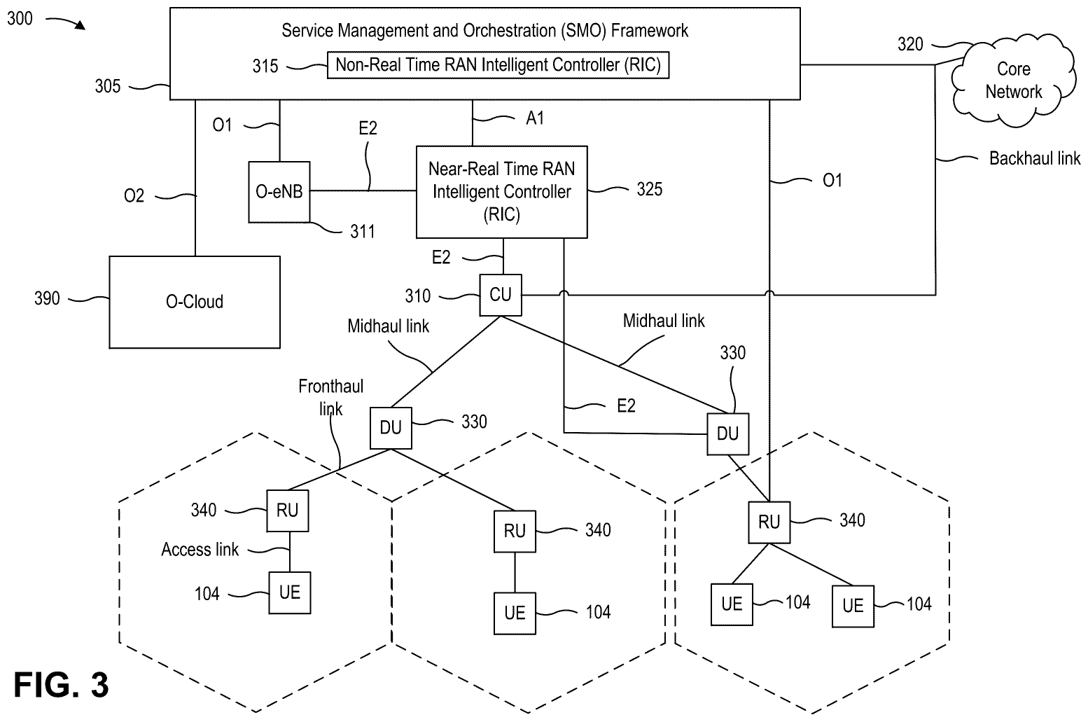

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit—User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

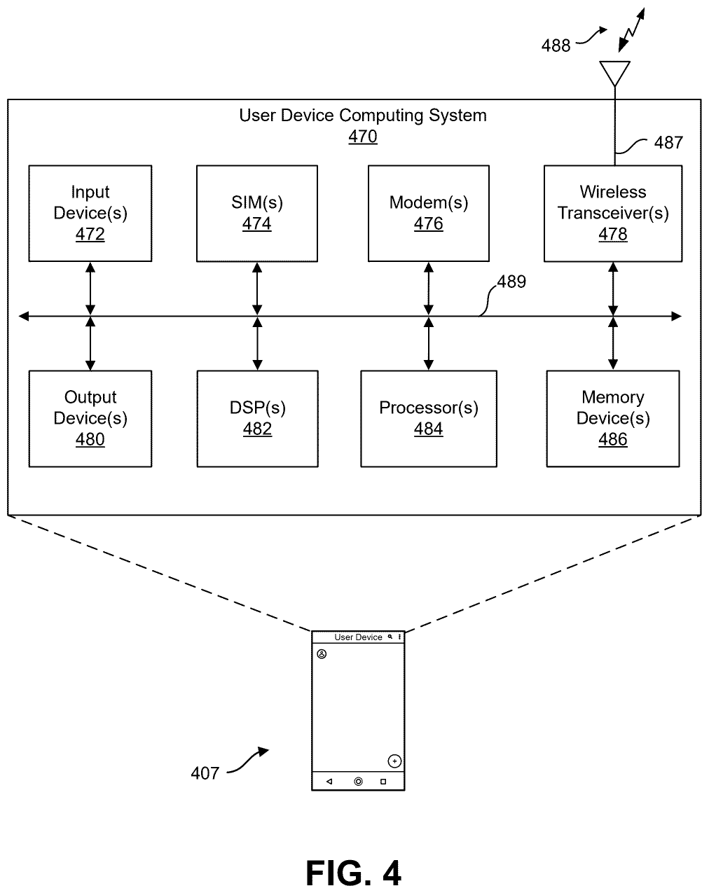

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmitRF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

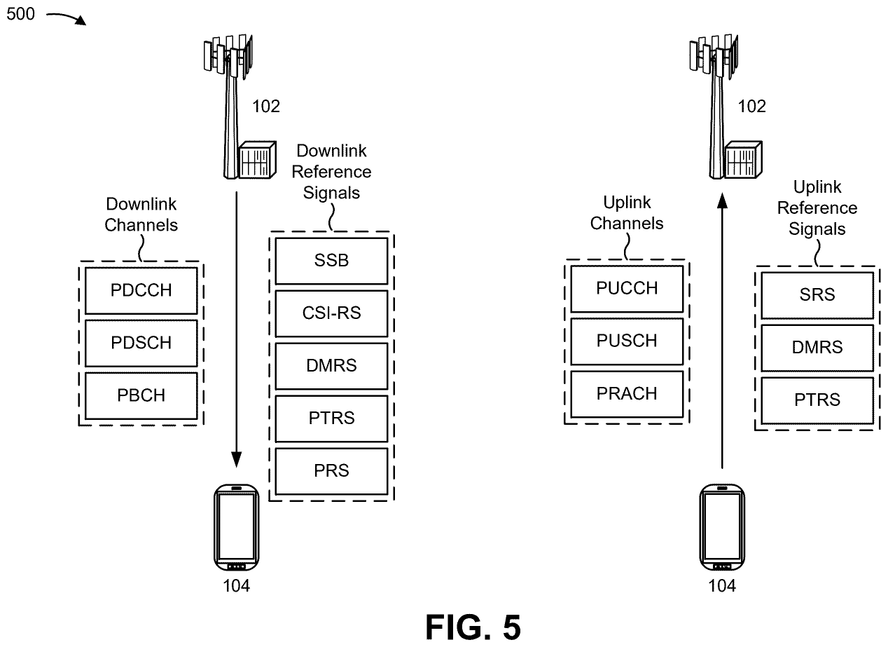

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

As noted above, systems and techniques are described herein for beam failure recovery (BFR) that can be performed using one or more BFR configuration parameters and/or values that are determined by a UE. In some examples, beam failure recovery by a UE can correspond to one or more beam failures detected corresponding to a beam transmitted between a network entity (e.g., base station, gNB, etc.) and a UE and/or corresponding to beamformed communications between a network entity and a UE.

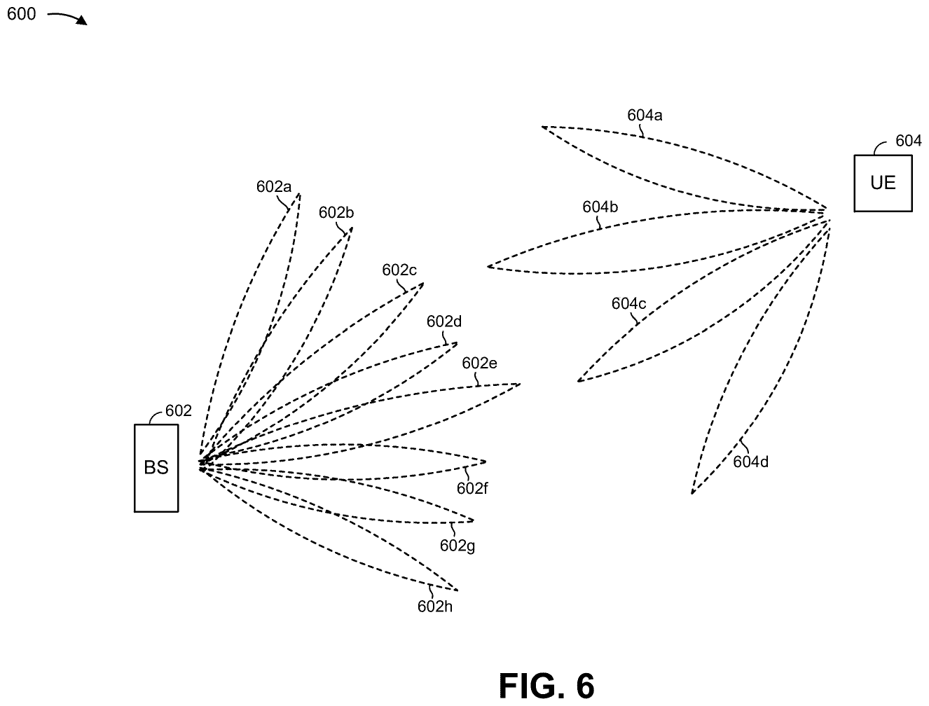

FIG. 6 is a diagram illustrating an example of communications 600 between a base station 602 and a UE 604 using one or more beams, in accordance with some examples. Some wireless communications networks (e.g., such as 5G NR wireless communications networks, etc.), may employ beamforming at mmW or near mmW frequencies to increase the network capacity. The use of mmW frequencies may be in addition to microwave frequencies (e.g., in the “sub-6” GHz, or FR1, band) that may also be supported for use in communication, such as when carrier aggregation is used. In some examples, the base station 602 and the UE 604 may correspond to any of the base stations and UEs described herein that are capable of beamforming, such as the base station 102 and the various UEs 104 of FIG. 1, and/or any other base station and/or UE of various ones of FIGS. 1-5, etc.

In some examples, the base station 602 may transmit a beamformed signal to the UE 604 on one or more beams 602a, 602b, 602c, 602d, 602e, 602f, 602g, 602h, each beam having a respective beam identifier that can be used by the UE 604 to identify the beam. In examples where the base station 602 is beamforming towards the UE 604 with a single array of antennas, the base station 602 may perform a beam sweep by transmitting first beam 602a, then beam 602b, and so on until lastly transmitting beam 602h. In other examples, the base station 602 may transmit beams 602a-602h in a configured pattern, order, sequence, etc. (e.g., such as beam 602a, then beam 602h, then beam 602b, then beam 602g, and so on). Where the base station 602 is beamforming towards the UE 604 using multiple arrays of antennas, each antenna array may perform a beam sweep of a subset of the beams 602a-602h. In some examples, each of beams 602a-602h may correspond to a single antenna or antenna array.

The UE 604 may receive the beamformed signal from the base station 602 on one or more receive beams 604a, 604b, 604c, 604d. The UE 604 may also transmit a beamformed signal to the base station 602 on one or more of the beams 604a-604d, and the base station 602 may receive the beamformed signal from the UE 604 on one or more of the beams 602a-602h. Because communication at high mmW frequencies utilizes directionality (e.g., communication via directional beams 602a-h and 604a-d) to compensate for higher propagation loss, the base station 602 and the UE 604 may need to align their transmit (and receive) beams during both initial network access and subsequent data transmissions to ensure maximum gain. The base station 602 and the UE 604 may determine the best beams for communicating with each other, and the subsequent communications between the base station 602 and the UE 604 may be via the selected beams. Thus, the base station 602 and the UE 604 may perform beam training to align the transmit and receive beams of the base station 602 and the UE 604. For example, depending on environmental conditions and other factors, the base station 602 and the UE 604 may determine that the best transmit and receive beams are 602d and 604b, respectively, or beams 602e and 604c, respectively. The direction of the best transmit beam for the base station 602 may or may not be the same as the direction of the best receive beam, and likewise, the direction of the best receive beam for the UE 604 may or may not be the same as the direction of the best transmit beam.

However, due to UE mobility/movement, beam reconfiguration at the base station 602, and/or other factors, a downlink beam (e.g., comprising a downlink control link), which may have been the preferred active beam, may fail to be detected at the UE 604, or the signal quality may fall below a threshold, causing the UE 604 to consider it as a beam/link failure. Abeam recovery procedure may be employed to recover from such a beam failure. A beam failure may refer to, for example, failure to detect a strong (e.g., with signal power greater than a threshold) active beam, which may, in some aspects, correspond to a control channel communicating control information from the network. In certain aspects, in order to facilitate beam failure detection, a UE (e.g., UE 604) may be preconfigured with beam identifiers (IDs) of a first set of beams (referred to as “set_q0”) to be monitored, a monitoring period, an RSRP threshold, etc. The recovery may be triggered when an RSRP associated with the one or more monitored beams (as detected by the UE 604) falls below a threshold. The recovery process may include the UE 604 identifying a new beam, for example, from a second set of possible beams (corresponding to beam IDs that may be included in a second set, referred to as “set_q1”), and performing a RACH procedure using preconfigured time and frequency resources corresponding to the new preferred beam. The beam IDs corresponding to the beams in the second set of beams (set_q1) may be preconfigured at the UE 604 for use for beam failure recovery purposes. For example, the UE 604 may monitor DL beams (based on the beam IDs and resources identified in the second set), perform measurements, and determine (e.g., based on the measurements) which beam out of all received and measured beams may be the best for reception at the UE 604 from the UE's 604 perspective.

If beam correspondence is assumed (e.g., the direction of the best receive beam used by the UE 604 is also considered the best direction for the transmit beam used by the UE 604), then the UE 604 may assume the same beam configuration for both reception and transmission. That is, based on monitoring downlink reference signals from the base station 602, the UE 604 can determine its preferred uplink transmit beam weights, which will be the same as for the downlink receive beam used for receiving the downlink reference signals.

Where beam correspondence is not assumed (e.g., deemed not suitable in the given scenario or for other reasons), the UE 604 may not derive the uplink transmit beam from the downlink receive beam. Instead, separate signaling is needed to select the uplink transmit and downlink receive beam weights and for the uplink-to-downlink beam pairing. The UE 604 may perform a RACH procedure (e.g., using the preconfigured time and frequency resources indicated in the second set of beams, set_q1) to identify the uplink transmit beam. Performing the RACH procedure using the preconfigured time and frequency resources may comprise, for example, transmitting a RACH preamble on one or more uplink transmit beams (corresponding to the beam IDs in the second set of beams, set_q1) on allocated RACH resources corresponding to the one or more beams. Based on the RACH procedure, the UE 604 may be able to determine and confirm with the base station 602 which UL direction may be the best beam direction for an UL channel (e.g., PUCCH). In this manner, both UL transmit and DL receive beams may be reestablished and beam recovery may be completed.

In certain aspects, carrier aggregation may be utilized where the communication between the base station 602 and the UE 604 is supported by multiple carrier components (e.g., a PCell and one or more SCells). For example, the PCell may correspond to a microwave frequency band and/or other relatively lower frequency band (e.g., an FR1 band or sub-6 band) compared to the mmW frequency band, while the one or more SCells may correspond to mmW frequency bands (e.g., an FR2 band). In an aspect, when PCell and SCell operation is supported in the communications system and there is no correspondence between uplink receive and downlink transmit beams, assistance from the PCell may be leveraged to enhance an SCell recovery procedure. In other words, if the beam/link failure occurs in the SCell, assistance from the PCell may be leveraged to facilitate the SCell beam recovery procedure. Such an approach may reduce the delays and latencies associated with the beam recovery procedure and allow for faster recovery of a failed link in the SCell.

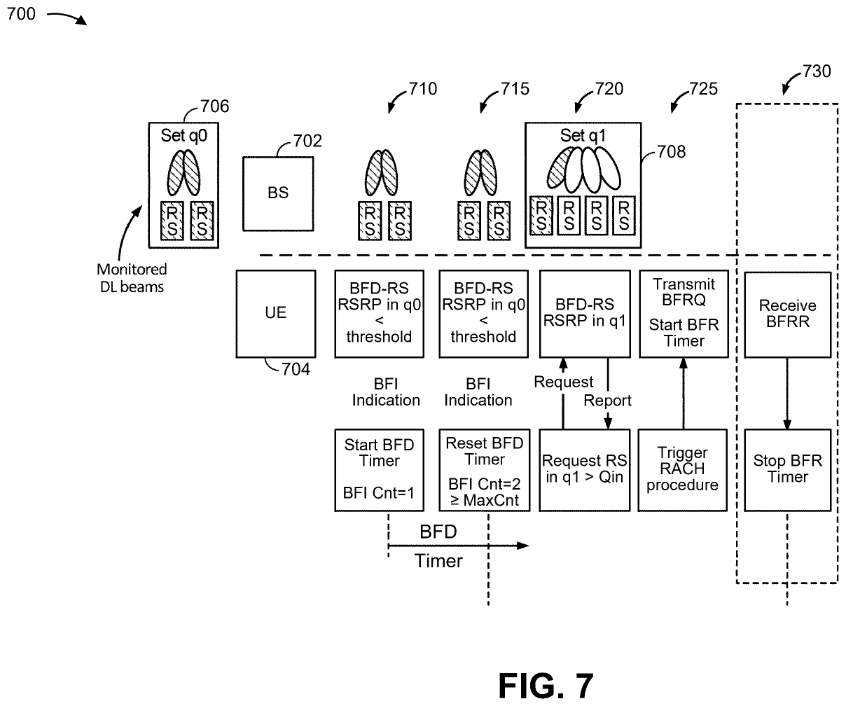

FIG. 7 is a diagram illustrating an example random access channel (RACH)-based beam failure recovery (BFR) procedure 700, in accordance with some examples. For example, the BFR procedure 700 can be performed between a base station 702 and a UE 704, where the UE 704 is associated with the base station 702 (e.g., where the base station 702 is a serving gNB or serving base station of the UE 704, etc.). In some examples, the UE 704 can be the same as or similar to one or more of the UEs of FIGS. 1-6, and the base station 702 can be the same as or similar to one or more of the base stations of FIGS. 1-6.

In some aspects, the example BFR procedure 700 of FIG. 7 may be performed by a UE and configured to indicate to the serving gNB of a new SSB or CSI-RS that the UE has experienced and/or detected a beam failure on the serving SSB(s) or CSI-RS(s), respectively. For example, the UE 704 can perform the BFR procedure 700 to indicate the detection of beam failure on one of the monitored DL beams 706, where the UE 704 indicates the detected beam failure to the BS 702 associated with (e.g., configured to transmit) the DL beams 706 that are monitored by the UE 704 and for which the beam failure is detected.

For example, the UE 704 can be configured to monitor the received signal strength (e.g., RSRP) of periodic reference signals transmitted by the base station 702 on a first set (e.g., “set q0”) of downlink transmit beams 706. The first set of downlink transmit beams 706 may correspond to one or more of the beams 602a-602h of FIG. 6. In some aspects, the first set of downlink transmit beams 706 can be Beam Failure Detection (BFD) Reference Signal (BFD-RS) beams. For example, the first set of downlink transmit beams 706 can be BFD-RS beams that are based on Beam Failure Recovery (BFR) configuration information provided or transmitted from the BS 702 to the UE 704. In the example of FIG. 7, the first set of downlink transmit beams 706 includes two beams (e.g., a first BFD-RS and a second BFD-RS). In some examples, the set of downlink transmit beams 706 may include a single beam (e.g., a single BFD-RS) and/or may include more than two beams (e.g., more than two BFD-RSs).

The BFR configuration information can be associated with the example BFR procedure 700 implemented by the UE. For example, the BFR configuration information from the BS 702 to the UE 704 can be transmitted prior to the UE 704 performing the BFR procedure 700. In some aspects, the BFR configuration information can be indicative of one or more BFD-RSs for performing BFR by the UE 704. For example, the BFR configuration information can be indicative of the BDF-RSs included in the set of DL beams 706 of FIG. 7. In some aspects, the BFR configuration information can be indicative of one or more configured timer values or timer lengths, including a BFD timer (e.g., started when the UE 704 detects a first beam failure instance (BFI) and begins incrementing a BFI counter) and/or a BFR timer (e.g., started when the UE 704 transmits a Beam Failure Recovery Request (BFRQ) in response to the BFI counter exceeding a configured value before the BFD timer expires, and indicative of a maximum elapsed time for the UE 704 to receive a Beam Failure Recovery Response (BFRR) after sending the BFRQ). In some examples, the BFR configuration information can be indicative of a threshold or maximum value for the BFI counter, where the UE 704 is configured to trigger a BFR based on the BFI counter being equal to or exceeding the configured threshold value for the BFI counter within the duration of the BFD timer. In some examples, the BFR configuration information can be indicative of one or more RACH resources for performing the beam failure recovery by the UE 704. In one illustrative example, the BFR configuration information can be signaled from the BS 702 (and/or other network entity) to the UE 704 as beamFailureRecoveryConfig information.

At 710, the UE 704 fails to detect a periodic reference signal transmitted on at least one of the beams in the first set of downlink transmit beams 706, and/or detects that a quality metric (e.g., RSRP) associated with the reference signal (e.g., a BFD-RS of the first set of monitored DL beams 706) has fallen below a configured signal quality threshold. For example, the particular BFD-RS for which the RSRP is measured and/or the set of BFD-RS beams 706 can be indicated and/or configured for the UE 704 based on the BFR configuration information (e.g., beamFailureRecoveryConfig information) transmitted previously by the base station 702. In some aspects, the RSRP threshold to which the measured RSRP of the BFD-RS is compared may be configured based on the same BFR configuration information from the base station 702. Based on a determination that the measured RSRP for the BFD-RS is less than the configured RSRP threshold and/or is less than or equal to the configured RSRP threshold, the UE 704 can determine that a Beam Failure Instance (BFI) has been detected. Detection of a respective BFI can cause the UE 704 to generate a corresponding BFI indication.

For example, at 710, the UE 704 can determine that the beam quality of the monitored BFD-RS(s) within the set of monitored DL RS beams 706 has fallen below the configured RSRP threshold for beam failure detection. In response to the initial determination of a measured BFD-RS RSRP<configured RSRP threshold, the UE can generate a first BFI indication and can start a beam failure instance. Starting the beam failure instance at 710 can correspond to the UE 704 initializing a BFD timer and a BFI counter. The BFI counter can be initialized to a value of ‘0’ and incremented to a value of ‘1’ in response to the BFI indication at 710. In some aspects, the BFI counter can be initialized to a value of ‘1’ and is not incremented at 710. In both cases, the BFI counter value is equal to ‘1’ after the BFI indication is generated at 710.

The BFI counter can be incremented corresponding to each BFI indication that is detected by the UE within the configured time duration for the BFD timer. Based on the BFI counter being greater than or equal to a configured maximum or threshold number of BFI indications before the expiration of the BFD timer, the UE 704 can determine that a beam failure has occurred and may initiate beam failure recovery. If the BFD timer expires and the BFI counter is less than the configured threshold value of BFI indications for a BFD event and for triggering the BFR, the UE 704 determines that beam failure has not occurred and does not perform beam failure recovery, and the beam failure instance started at 710 can be terminated and/or the BFD timer and BFI counter can be re-initialized based on the BFR configuration information previously received by the UE 704 from the base station 702.

For example, at 715, the UE 704 may again fail to detect the periodic reference signal transmitted on the at least one of the beams in the first set of downlink transmit beams 706, and/or may again detect that the quality metric associated with the reference signal has fallen below the configured threshold. In one illustrative example, at 715 the UE 704 can detect a second occurrence of a measured BFD-RS RSRP<configured RSRP threshold (e.g., a second instance of the measured RSRP for the same BFD-RS again being below the configured RSRP threshold). The UE 704 can generate a BFI indication, which causes the BFI counter to be incremented to a value of ‘2’.

In one illustrative example, the BFD timer continues to run or accumulate between the BFI indication at 710 and the BFI indication at 715. In some aspects, for a BFR configuration information with a configured maximum BFI count equal to ‘2’, detection of the second BFI at 715 can cause the UE 704 to determine that a BFD has occurred, and may trigger the UE 704 to initiate the beam failure recovery (e.g., BFR procedure or BFR process configured by the BFR configuration information from the base station 702). Based on the BFI counter reaching the maximum count (e.g., “MaxCnt”) threshold while the BFD timer is running (e.g., before the BFD timer expires), the ULE 704 can determine that there has been a beam failure of at least one beam in the set of monitored DL beams 706. In some aspects, because there is a failure of a downlink control beam (corresponding to the downlink control channel communicating control information from the network), the UE 704 assumes that there is also a failure of the corresponding uplink control beam (corresponding to the uplink control channel for communicating control information to the network), and the BFR procedure performed by the UE 704 can include identifying a new downlink control beam and re-establishing an uplink control beam with the base station 702.

At 720, in response to the beam failure detection at 715, the UE 704 initiates a beam failure recovery procedure. For example, the UE 704 can initiate and perform the beam failure recovery procedure to identify at least one beam in a second set (“set_q1”) of downlink transmit beams 708 that carries a periodic reference signal with a received signal strength greater than a signal quality threshold (represented as “Qin”). The second set of downlink transmit beams 708 may correspond to one or more of beams 602a-602h of FIG. 6. The second set of downlink transmit beams 708 can be referred to as candidate beams and/or can be referred to as a candidate beam reference signal list. The UE 704 may receive both the beam IDs of the beams in the second set of downlink transmit beams 708 and the Qin threshold from the base station 702. In the example of FIG. 7, the second set of downlink transmit beams 708 includes four beams, one of which (shaded) carries periodic reference signals having a received signal strength greater than the Qin threshold. In some aspects, there may be more or fewer than four beams in the second set of downlink transmit beams 708, and there may be more than one beam that meets the Qin threshold. The identified candidate beam can then be used as the new downlink control beam for the UE 704.

At 725, to re-establish an uplink control beam, the UE 704 performs a RACH procedure on the one or more candidate downlink transmit beams identified at 720 (e.g., one candidate beam identified from the set of four candidate beams in the set q1 708 in the example of FIG. 7). For example, the UE 704 can be configured to transmit a RACH preamble to the base station 702. The RACH preamble can be stored in memory by the UE 704 and/or can be provided (e.g., transmitted to, configured for, etc.) the UE 704 by the base station 702. The UE 704 can transmit the RACH preamble (also referred to as a Message 1, Msg1, or RACH request) on one or more uplink transmit beams corresponding to the one or more candidate downlink transmit beams identified at 720 on preconfigured RACH resources for the one or more candidate uplink transmit beams.

In one illustrative example, the UE 704 performs candidate beam identification in response to the BFI Count reaching the configured BFI MaxCnt threshold. For example, the UE 704 can perform candidate beam identification to search for a candidate beam that can be used to recover the link with the base station 702. The UE 704 can perform the candidate beam identification based on measuring the quality (e.g., RSRP) of the one or more available candidate beams from the candidate list (e.g., the set of beams q1 708, etc.). The UE 704 can be configured to select the best candidate beam based on the respective RSRP measurements. In some cases, the UE 704 can be configured to select a candidate beam for recovery (e.g., from the candidate beam list and/or set of candidate beams q1 708) based on the BFR configuration information previously received by the UE 704 from the base station 702.

Based on identifying or selecting a best candidate beam or other candidate beam for use in the beam failure recovery, the UE can transmit a Beam Failure Recovery Request (BFRQ) to the base station 702 using the selected candidate beam. The BFRQ can include or otherwise indicate information corresponding to the failed beam and/or information corresponding to the selected candidate beam. In some aspects, the UE 704 can start a BFR Timer in response to transmitting the BFRQ to the base station 702. The BFR Timer can correspond to a maximum configured time duration or elapsed time for the UE 704 to receive a corresponding Beam Failure Recovery Response (BFRR) from the base station 702, where the BFRR is responsive to the BFRQ transmitted by the UE 704. In some aspects, the BFR timer corresponds to a contention-free random access (CFRA) window.

At 730, the base station 702 transmits a RACH response (referred to as a “Msg1 response,” or a “Msg2”) to the UE 704 with a cell-radio network temporary identifier (C-RNTI) via a PDCCH. For example, the response may comprise cyclic redundancy check (CRC) bits scrambled by the C-RNTI. In some aspects, the RACH response from the base station 702 can be a Beam Failure Recovery Response (BFRR).

For example, if the base station 702 receives the BFRQ transmitted by the UE 704 at 725, and if the base station 702 agrees with the candidate beam selection indicated by the BFRQ, at 730 the base station 702 can be configured to transmit a BFRR to the UE 704. The BFRR can be indicative of a confirmation by the base station 702 of the new beam configuration indicated by the UE 704 in the BFRQ. Based on receiving the BFRR, the UE 704 can switch to the new candidate beam for communication with the base station 702. If the base station 702 does not receive the BFRQ or disagrees with the candidate beam selection of the UE 704, the base station 702 can be configured not to send a BFRR. If the UE 704 does not receive a BFRR within the configured maximum time duration or time window of the BFR timer (e.g., configured based on the BFR configuration information signaled previously from the base station 702 to the UE 704), the UE 704 considers the beam failure recovery attempt as failed. The beam failure instance counter (e.g., BFI counter) can be incremented and the UE 704 may repeat the process above. If the UE 704 receives a BFRR from the base station 702, the UE 704 can consider the beam failure recover process 700 as successful, and can be configured to stop the BFR timer, reset the BFI counter, and begin using the new (e.g., selected) candidate beam for communication.

In one illustrative example, the systems and techniques described herein can be used to provide flexible BFR configurations for a UE, where the UE is configured to determine one or more BFR configuration parameters based on radio condition information associated with the UE. For example, in some aspects, the network entity (e.g., base station, gNB, etc.) can transmit BFR configuration information the UE, where the BFR configuration information is indicative of one or more flexible BFR configuration triggers for performing a BFR procedure by the UE.

In some examples, the network entity can transmit BFR configuration information indicative of a minimum and maximum value corresponding to a range of values within which the UE can select the BFR configuration parameter value for the BFI counter threshold (e.g., “MaxCnt” in FIG. 7, etc.). For example, the network entity can indicate to the UE a minimum and maximum value (e.g., can indicate a range of values) for the beamFailureInstanceMaxCount BFR configuration parameter. The UE can utilize its local radio condition information and/or knowledge of the traffic type and/or traffic characteristics of the radio traffic associated with the UE to select a particular value for the BFI counter threshold from within the indicated range received from the network entity.

For example, the UE can select a relatively low value (e.g., within the indicated beamFailureInstanceMaxCount range) for the BFI counter threshold, where the relatively low value corresponds to earlier or quicker beam failure detection, and an earlier or quicker initiation of the BFR procedure. For example, as noted above, the UE can determine a BFD has occurred and can trigger the BFR procedure in response to the BFI counter being greater than or equal to the configured BFI counter threshold value. The UE selecting a lower value for the BFI counter threshold can correspond to detecting the BFD event and initiating the BFR procedure after the UE detects a lesser number of individual BFIs (e.g., such as the first BFI at 710 of FIG. 7, the second BFI at 715 of FIG. 7, etc.).

Based on selecting a relatively high value (e.g., within the indicated beamFailureInstanceMaxCount range) for the BFI counter threshold, the UE can configure or adjust its BFR procedure to utilize a delayed initiation of the beam failure recovery. For example, selecting or determining a relatively high value for the BFI counter threshold can correspond to the UE detecting the BFD event and initiating the BFR procedure after the UE detects a greater number of individual BFIs within the time duration or window of the BFD timer (e.g., where the BFD timer is started from the detection of the first BFI, such as the first BFI at 710 of FIG. 7).

In some aspects, the UE can receive (e.g., from the network entity) BFR configuration information that is indicative of a plurality of permitted or candidate values from which the UE can select a particular value for use as the BFI counter threshold. For example, the network entity can indicate the candidate values for the BFI counter threshold via respective indices within the BFR configuration information. In some cases, the BFR configuration information can include a minimum and maximum value of the beamFailureInstanceMaxCount parameter to indicate that the UE may select the BFI counter threshold from the continuous range of integers between the minimum and maximum values (e.g., 2, 3, 4, 5, . . . , etc.). In some cases, the BFR configuration information can include respective indices for permitted or candidate values of the BFI counter threshold to indicate that the UE may select from a discontinuous set or range of integers (e.g., 2, 3, 5, 8, . . . , etc.).

In some examples, the BFR configuration information can provide multiple reference signals that can be configured simultaneously for beam failure detection monitoring by the UE. For example, the UE may receive BFR configuration information that causes the UE to perform monitoring of a plurality of different reference signal beams (e.g., BFD-RSs) each indicated in the BFR configuration information. The BFR configuration information can include a corresponding MaxCount value (e.g., BFI counter threshold) for determining a BFD event on each of the respective reference signal beams (e.g., BFD-RSs) that are configured simultaneously.

In some cases, the BFR configuration information can indicate multiple different RACH configurations that can be used by the UE to perform the beam recovery and/or to identify and select a candidate beam for the recovery. For example, the multiple different RACH configurations can correspond to the RACH procedure at 725 of FIG. 7. In some aspects, the multiple RACH configurations indicated in the BFR configuration from the network entity can be used to provide the UE with increased flexibility, for example to apply different RACH configurations based on the radio conditions currently experienced by the UE during the beam failure recovery process.

In some examples, the BFR configuration information can indicate that the UE may flexibly select the candidate beam list from set one or set two based on the BFD-RS for which the monitoring and beam failure are detected by the UE. In some cases, the BFR configuration information can indicate a range of values of RSRP thresholds that can be used by the UE to determine that a particular beam (e.g., BFD-RS) is or is not experiencing a BFI. For example, the UE may generate a BFI indication in response to a measured RSRP for a BFD-RS being less than or equal to a configured RSRP threshold. The configured RSRP threshold may be static and/or the same across different BFD-RSs that may be monitored by the UE. In some cases, the configured RSRP threshold may be dynamic or adjustable.

For example, the configured RSRP threshold may be different for different BFD-RSs that may be monitored by the UE. In some cases, the BFR configuration information can be indicative of a maximum and minimum RSRP threshold value, between which the UE can determine a particular RSRP threshold value to be used for determining the occurrence of a BFI for a particular BFD-RS. In some aspects, the BFR configuration information can indicate arrange of RSRP threshold values within which the UE may select an optimal RSRP threshold value to use for determining the occurrence of a BFI, for example based on the current radio and/or traffic conditions at the UE. The RSRP threshold value range can be indicated as the range (e.g., maximum minus minimum values) and at least one reference point within the range (e.g., minimum value, mid-point value, maximum value, etc.). In some examples, the RSRP threshold value range can be indicated using only the minimum value and the maximum value. In some aspects, the BFR configuration information can indicate a range of values of RSRP thresholds for SSB and/or for BFD-RSs.

In some aspects, the BFR configuration information can be indicative of a range of values within which the UE may select the BFD timer duration. In some cases, the BFR configuration information can be indicative of a range of values within which the UE may select the BFR timer duration. The BFD timer duration and the BFR timer duration may be selected from the same range, or may be selected from separate ranges of values (e.g., a first range of values for UE selection of the BFD timer duration, and a second range of values for UE selection of the BFR timer duration). In some cases, the BFR configuration may indicate a maximum value for the BFD timer duration, a maximum value for the BFR timer duration, or both. In some examples, the range of BFD timer duration values available for the UE to implement during the BFR process can be based on the selected or configured value used for the BFR timer duration value, and vice versa. In some examples, the network entity can transmit BFR configuration information that indicates the UE may select any desired value for one or more of the BFR configuration parameters noted above (e.g., the UE may select and implement BFR configuration parameter values that are not constrained to be within a specified range of values indicated from the network entity to the UE).

In one illustrative example, the BFR configuration information from the network entity to the UE does not specific a configured value or a configured range of values from which the UE may make a selection. For example, BFR configuration information that does not include one or more values or other configuration information for a respective BFR configuration parameter can be used to implicitly signal that the UE can flexibly trigger, initiate, and/or perform the BFR procedure based on UE-specific events or knowledge (e.g., including current radio and/or traffic conditions determined by the UE, etc.). For example, BFR configuration information that does not include one or more values for the MaxCount parameter of the BFI counter threshold may indicate that the UE can implement any value for the BFI counter threshold maximum.

In one illustrative example, the UE can determine that the current radio conditions at the UE correspond to relatively fast deterioration of beam quality (e.g., in a relatively short amount of time, a beam can transition from being above the RSRP threshold and not causing a beam failure instance (BFI) indication, to being below the RSRP threshold and causing a BFI indication). Based on the radio conditions at the UE being associated with relatively fast deterioration, the UE can select and implement a corresponding value for the BFI counter MaxCount parameter. In another example, the UE can determine that the current radio conditions correspond to relatively slow deterioration of beam quality, and may select and implement a different (e.g., higher or lower) value for the BFI counter MaxCount parameter than is used in the relatively fast deteriorating conditions.

In some cases, the BFR configuration information can indicate different BFR configuration triggers, values, and/or value ranges corresponding to respective conditions that may be detected or determined by the UE. For example, the BFR configuration information can indicate flexibility for the UE to select or chose the BFD-RS and corresponding RSRP threshold(s) for detecting a BFI, based on the radio conditions present at the UE. For example, fast deteriorating radio conditions can be mapped to a first set of BFR configuration options for the UE. Slowly deteriorating radio conditions can be mapped to a second set of BFR configuration options for the UE. Ping-ponging radio conditions (e.g., changing back and forth between slow deterioration and fast deterioration, etc.) can be mapped to a third set of BFR configuration options for the UE.

In some aspects, the BFR configuration information can indicate that the ULE may flexibly chose among the various candidate beams of the candidate beam list (e.g., associated with the RACH procedure for beam recovery, such as the RACH procedure at 725 of FIG. 7, etc.). For example, the BFR configuration information can by default cause the ULE to choose the best candidate beam for recovery as the candidate beam for which the UE measures the strongest RSRP. In some examples, the BFR configuration information can configure the UE to select the candidate beam to be used for recovery according to a logic chosen by the UE (e.g., which can be based on RSRP, or may be based on factors or criteria other than the candidate beam RSRPs, etc.).

In some cases, the UE can implement one or more machine learning (ML) and/or artificial intelligence (AI) models that are trained to determine BFR configuration information and/or BFR parameter values that are optimized for the dynamic radio conditions, traffic patterns, etc., that are currently or previously experienced by the UE. For example, the UE can include and/or implement an ML/AI scheduler that is used to perform scheduling associated with uplink and/or downlink transmissions and/or communications between the UE and a network entity (e.g., base station, gNB, etc.). In some aspects, the UE can utilize one or more local ML or AI models implemented by the UE to determine dynamic BFR configuration information to initiate and/or perform a BFR. In some examples, the UE may utilize the one or more local ML or AI models to determine dynamic BFD parameters for detecting a beam failure event to trigger or initiate the BFR procedure. In one illustrative example, the UE can utilize an AI/ML scheduler to determine and trigger the BFR procedure autonomously, for example using modifier BFI counter threshold values determined by the AI/ML scheduler, using one or more BFD-RSs selected by the AI/ML scheduler for identifying a BFD event and triggering the BFR procedure to initiate using dynamically selected RACH resources, etc. In some aspects, the AI/ML scheduler can also be referred to as a scheduling engine and/or an AI/ML scheduling engine of the UE. The AI/ML models used by the UE for the autonomous or semi-autonomous configuration of the BFR procedure (e.g., BFR configuration parameter values, BFR triggers, BFR beam and/or resource selection, etc.) can be implemented by the UE without coordination with the network entity. In some cases, the AI/ML models used by the UE for the autonomous or semi-autonomous configuration of the BFR procedure can be coordinated at least in part between the UE and the network entity. The AI/ML models may be implemented by the UE inside of the radio domain and/or may be implemented by the UE outside of the radio domain.

In some cases, the UE can dynamically modify or adapt one or more BFR configuration parameter values, including BFR configuration parameter values that are signaled as a static BFR configuration from the network entity and/or including BFR configuration parameter values, ranges, options, etc., that the network entity configures as available for selection by the UE. For example, the BFR procedure triggering and recovery process can be modified dynamically by the UE based on one or more of the detected radio conditions for the UE and/or UE-specific knowledge. For example, the UE may determine and implement modified values for the BFI counter threshold MaxCount based on the current radio conditions at the UE. A lower value can be dynamically implemented for the BFI counter MaxCount based on the UE determining that the RSRP measurement(s) are below a configured threshold value to thereby speed up the initiation of the beam recovery.

In some examples, the UE can dynamically determine and implement modified values for the BFD timer and/or BFR timer duration(s), based on the detected radio conditions for the UE (e.g., the current or previous radio conditions at the UE, as detected or determined by the UE). For example, the UE may dynamically determine and implement increased or relatively longer BFD and/or BFR timer durations in order for the UE to continue using the RACH CFRA option for the BFRA procedure. In another example, the UE may dynamically determine and implement shorter BFD and/or BFR timer durations if the UE will not continue to use the RACH CFRA option. In some aspects, the UE can select and/or modify the BFD and/or BFR timer durations based on the RACH resource configuration and contention associated with performing the beam failure recovery.

In some aspects, the UE can be configured to flexibly choose the RSRP threshold(s) for detecting a BFI (e.g., RSRP thresholds for the BFD). In some aspects, the UE may choose the RSRP thresholds based on the RS type of the monitored beam (e.g., the type of reference signal being monitored in the BFD-RS associated with the BFI and BFD, etc.) and/or reporting the BFI to MAC. In some examples, the UE can be configured with flexibility to choose a candidate beam for recovery which may not be the best candidate beam based on RSRP measurements. For example, the UE may utilize criteria other than and/or in addition to the candidate beam RSRP measurement value for determining the particular candidate beam that is selected for performing the beam recovery and identified to the network entity in the BFRQ transmitted from the UE to the network entity. In some examples, the UE can be configured with flexibility to choose the RACH resources and powerRampstep or RACH occasions for performing the beam recovery. In some aspects, the UE can be configured with the flexibility to select between CFRA and CBRA RACH procedures for performing the beam recovery. In some cases, the UE can be configured with the flexibility to choose from two different sets of BFD sets.

Using the one or more AI/ML models implemented by the UE, in some aspects the UE can autonomously trigger the BFR procedure with one or more of a modified BFD and/or BFR trigger, a modified BFD and/or BFR timer duration, RS-based RSRP threshold values, and/or associated RACH procedure(s) for successful indication of a new candidate beam to the network entity from the serving beam for which the BFD was detected. In some examples, the autonomous BFR triggers determined and implemented by the UE can be mapped to dynamically changing radio conditions for dynamic BFR adaptation implemented autonomously by the UE.

In some examples, the UE can track and report BFR configuration information to the network entity. For example, the UE can report the one or more UE-determined BFR configuration parameters utilized by the UE for different BFR instances. In some cases, the UE-determined BFR configuration parameters can be reported in combination with a BFR result or BFR outcome corresponding to the BFR procedure that was performed by the UE utilizing a respective set of the UE-determined BFR configuration parameters. For example, the UE can indicate to the network entity a number of beam failures configured by the UE for detecting or declaring the BFD (e.g., in some cases, based on RSRP as an additional dimension). The UE may indicate to the network entity a time to find candidate beam selection and successful BFR, RACH resources utilized, an optimal RSRP threshold for finding or selecting a new candidate beam, etc. The information can be indicated by the UE to the network entity utilizing event-based reporting associated with a BFR performed by the UE. For example, in some cases, the UE can transmit a Beam Failure Recovery Request (BFRQ) indicative of a BFD and/or BFR, where the BFRQ is further indicative of (e.g., extended to include) information corresponding to the internal parameters and UE-determined BFR configuration information implemented during the BFR performed by the UE. In some cases, the UE can perform periodic and/or consolidated reporting indicative of the respective internal parameters and UE-determined BFR configuration information utilized by the UE for multiple previous BFRs performed by the UE. In some cases, the BFR configuration information and BFR report information transmitted by the UE can be used for AI/ML model training, re-training, finetuning, etc., by the network entity, the UE, and/or both the network entity and the UE.

In some aspects, the BFR configuration information can be signaled from the network entity to the UE as a range or set of candidate BFR configuration values from which the UE may make a selection for performing the BFR procedure. For example, the network entity can indicate to the UE range information for the BFR timer using one or more minimum BFR timer duration values and one or more maximum BFR timer duration values. For example, the minimum BFR timer duration can be selected from a set of different available minimum BFR timer duration values given by beamFailureRecoveryTimer-min ENUMERATED {ms10, ms20, ms40, ms60, ms80, ms100, ms150, ms200}. In some examples, the maximum BFR timer duration can be selected from a set of different available maximum BFR timer duration values given by beamFailureRecoveryTimer-max ENUMERATED {ms10, ms20, ms40, ms60, ms80, ms100, ms150, ms200}.

In some cases, beam-specific RSRP threshold values can be configured rather than a common value for all candidate beams as rsrp-ThresholdSSB RSRP-Range information.

In some examples, the UE can configure, modify, and/or select a desired BFD detection trigger based on selecting from or between a set of allowed values for the BFI counter MaxCount. For example, the UE may select from a value range between an indicated BFI minimum counter threshold and an indicated BFI maximum counter threshold. In some cases, the range from which the UE may select and configure the BFI counter threshold for triggering a BFD can correspond to the range of values given by: beamFailureInstanceMinCount ENUMERATED {n1, n2, n3, n4, n5, n6, n8, n10}, and beamFailureInstanceMaxCount ENUMERATED {n1, n2, n3, n4, n5, n6, n8, n10}.

In some aspects, the value range for UE selection of the BFD timer duration can correspond to a range of BFD timer minimum durations (e.g., beamFailureDetectionTimer-Min ENUMERATED {pbfd1, pbfd2, pbfd3, pbfd4, pbfd5, pbfd6, pbfd8, pbfd10}) and a range of BFD timer maximum durations (e.g., beamFailureDetectionTimer-Max ENUMERATED {pbfd1, pbfd2, pbfd3, pbfd4, pbfd5, pbfd6, pbfd8, pbfd10}).

In some examples, the network entity can transmit BFR configuration information indicative of whether the UE is configured with flexibility to choose the RS for beam failure monitoring, radio link failure detection, or both in RadioLinkMonitoringRS purpose ENUMERATED {beamFailure, rlf, both}.

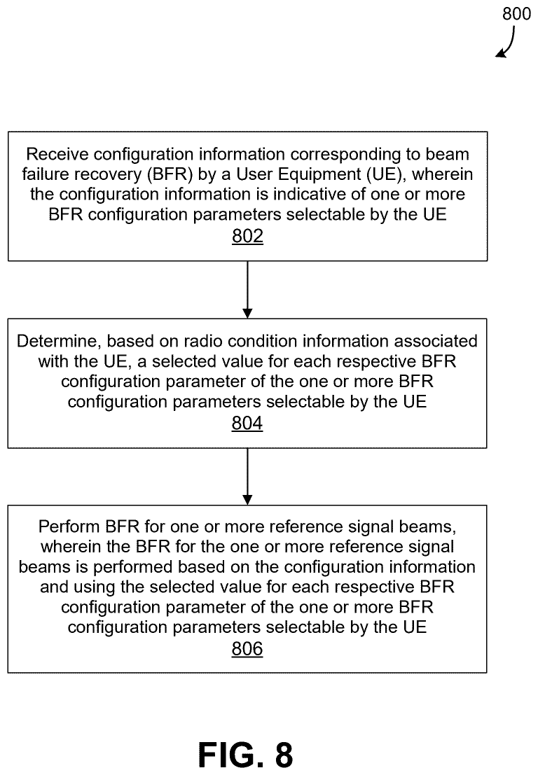

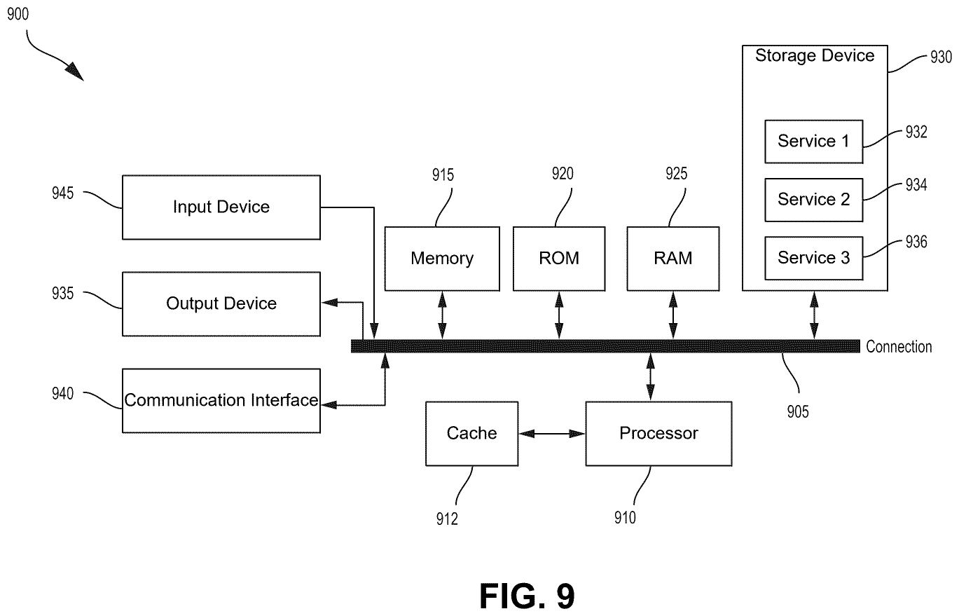

FIG. 8 is a flowchart diagram illustrating an example of a process 800 for wireless communications. For example, the process 800 can be a process for wireless communications by a UE. In some examples, the process 800 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 910 of FIG. 9 or other processor(s)). In some examples, the process 800 can be performed by a UE, including any of the UEs of FIGS. 1-7. In some aspects, the process 800 can be performed by a UE, smartphone, mobile computing device, user computer device, etc. The process 800 can be performed by a component or system (e.g., a chipset) of a wireless device (e.g., one or more of UEs 104, 152, 94, 182, 190 of FIG. 1; UE 104 of FIG. 2; UE(s) 104 of FIG. 3; wireless device 407 of FIG. 4; computing system 900 of FIG. 9; etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., processor 484 of FIG. 4, processor 910 of FIG. 9, and/or other processor(s)). Further, the transmission and reception of signals by the wireless device in the process 800 may be enabled, for example, by one or more antennas (e.g., antennas 252 of FIG. 2, antenna 487 of FIG. 4, etc.) and/or one or more transceivers (e.g., wireless transceiver(s) 478 of FIG. 4, etc.).

At block 802, the computing device (or component thereof) can receive configuration information corresponding to beam failure recovery (BFR) by a user equipment (UE), wherein the configuration information is indicative of one or more BFR configuration parameters selectable by the UE.

For example, the UE can be the same as or similar to one or more of the UEs of FIGS. 1-4. In some cases, the UE can be the same as or similar to the UE 104 of FIG. 2 and/or FIG. 3. In some cases, the UE can be the same as or similar to the UE 407 of FIG. 4 and/or another user device implementing the user device computing system 470 of FIG. 4. In some cases, the UE can be the same as or similar to the UE 604 of FIG. 6 and/or the UE 704 of FIG. 7.

In some examples, the UE can receive the configuration information from a network entity (e.g., base station, gNB, etc.). For example, the UE can receive the configuration from the base station 602 of FIG. 6 and/or the base station 702 of FIG. 7, etc. In some cases, the configuration information comprises beam failure recovery configuration information received from a network entity associated with the UE. For example, the beam failure recovery configuration information can be a beamFailureRecoveryConfig. The configuration information can be indicative of a corresponding plurality of configured values for each respective BFR configuration parameter of the one or more BFR configuration parameters selectable by the UE. For example, the corresponding plurality of configured values can be indicated as a value range between a minimum value and a maximum value. In some cases, the corresponding plurality of configured values can be indicated as a set of indices comprising a respective index for each configured value.

In some examples, the one or more BFR configuration parameters selectable by the UE includes one or more of: a beam failure instance (BFI) maximum count parameter, a beam failure detection (BFD) timer duration parameter, and/or a BFR timer duration parameter. In some cases, the BFI maximum count parameter can be a beamFailureInstanceMaxCount. For example, the BFI maximum count parameter can be the same as or similar to the “MaxCnt” parameter associated with the BFI Counter of FIG. 7.

In some examples, the BFD timer duration parameter can be indicated as a beamFailureDetectionTimer parameter or value. In some cases, the BFD timer duration parameter can be the same as or similar to the duration of the BFD timer of FIG. 7.

In some cases, the BFR timer duration parameter can be indicated as a beamFailureRecoveryTimer parameter or value. In some examples, the BFR timer duration parameter can be the same as or similar to the duration of the BFR timer depicted at block 730 of FIG. 7.

In some cases, the one or more BFR configuration parameters selectable by the UE can include a reference signal received power (RSRP) threshold value parameter corresponding to a beam failure detection (BFD) reference signal (BFD-RS) associated with the one or more reference signal beams. For example, the BFD-RS can be the same as or similar to one or more of the beams 602a-602h of FIG. 6. In some cases, the BFD-RS can be the same as or similar to one or more of the monitored DL beams 706 of FIG. 7, and/or the second set of beams 708 of FIG. 7, etc. In some examples, the one or more BFR configuration parameters selectable by the UE can include an identifier of the beam failure detection (BFD) reference signal (BFD-RS) associated with the one or more reference signal beams.

In some cases, the one or more BFR configuration parameters selectable by the UE can include a random access channel (RACH) configuration for candidate beam selection and beam recovery associated with the BFR by the UE. For example, the candidate beam selection and beam recovery can be associated with the RACH procedure at block 725 of FIG. 7. In some cases, the one or more BFR configuration parameters selectable by the UE can include an identifier of a candidate beam list for candidate beam selection and beam recovery associated with the BFR by the UE.

At block 804, the computing device (or component thereof) can determine, based on radio condition information associated with the UE, a selected value for each respective BFR configuration parameter of the one or more BFR configuration parameters selectable by the UE. In some cases, the radio condition information can be indicative of a deterioration speed associated with radio frequency (RF) communications corresponding to the UE.

In some examples, the configuration information can be indicative of a first BFR configuration including a first plurality of respective value ranges for the one or more BFR configuration parameters selectable by the UE, where the first BFR configuration corresponds to a relatively fast deterioration speed. The configuration information can be further indicative of a second BFR configuration including a second plurality of respective value ranges for the one or more BFR configuration parameters selectable by the UE, where the second BFR configuration corresponds to a relatively slow deterioration speed.

In some examples, the BFR by the UE can associated with a plurality of BFR configuration parameters, and the one or more BFR configuration parameters selectable by the UE comprises a first subset of the plurality of BFR configuration parameters in response to radio condition information indicative of a relatively fast deterioration speed, where the first subset is indicated in the configuration information. The one or more BFR configuration parameters selectable by the UE can comprise a second subset of the plurality of BFR configuration parameters in response to radio condition information indicative of a relatively slow deterioration speed, where the second subset is indicated in the configuration information.

In some cases, the computing device (or component thereof) can determine the selected value for each respective BFR configuration parameter based on processing the radio condition information using one or more machine learning (ML) models associated with the UE. For example, the one or more ML models can be included in a scheduling engine of the UE.

In some cases, the configuration information is indicative of a corresponding plurality of configured values for each respective BFR configuration parameter of the one or more BFR configuration parameters selectable by the UE. The selected value for each respective BFR configuration parameter can be determined as a selection from the corresponding plurality of configured values for each respective BFR configuration parameter. For example, the corresponding plurality of configured values can be indicated as a value range between a minimum value and a maximum value. In some cases, the corresponding plurality of configured values can be indicated as a set of indices comprising a respective index for each configured value.

At block 806, the computing device (or component thereof) can perform BFR for one or more reference signal beams, wherein the BFR for the one or more reference signal beams is performed based on the configuration information and using the selected value for each respective BFR configuration parameter of the one or more BFR configuration parameters selectable by the UE. The one or more reference signal beams can be received from a network entity associated with the UE, such as the network entity (e.g., base station) 602 of FIGS. 6 and/or 702 of FIG. 7, etc.

In some examples, performing BFR for the one or more reference signal beams can be associated with the RACH procedure at block 725 of FIG. 7 and the BFRR of block 730 of FIG. 7, etc.

In some cases, the computing device (or component thereof) can transmit, to a network entity, reporting information indicative of the selected value determined by the UE for each respective BFR configuration parameter of the one or more BFR configuration parameters selectable by the UE. For example, the configuration information corresponding to the BFR by the UE can be received from the network entity, and the reporting information can be included in a Beam Failure Recovery Request (BFRQ) transmitted from the UE to the network entity during the BFR for the one or more reference signal beams. In some cases, the BFRQ transmitted from the UE to the network entity can be the same as or similar to the BFRQ transmitted from the UE 704 to the base station (e.g., network entity) 702 at block 725 of FIG. 7.

In some cases, the reporting information is included in a periodic report transmitted from the UE to the network entity.

In some examples, the processes described herein (e.g., process 800, and/or other process described herein) may be performed by a computing device or apparatus (e.g., a network node such as a UE, base station, a portion of a base station, etc.). For instance, as noted above, the process 800 may be performed by a UE. In another example, the process 800 may be performed by a computing device with the computing system 900 shown in FIG. 9. For instance, a wireless communication device with the computing architecture shown in FIG. 9 may include the components of the UE and may implement the operations of FIG. 8.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 800 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 800 and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some aspects, computing system 900 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some aspects, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus of a user equipment (UE) for wireless communication, comprising: at least one memory; and at least one processor coupled to the at least one memory, wherein the at least one processor is configured to: receive configuration information corresponding to beam failure recovery (BFR) by the UE, wherein the configuration information is indicative of one or more BFR configuration parameters selectable by the UE; determine, based on radio condition information associated with the UE, a selected value for each respective BFR configuration parameter of the one or more BFR configuration parameters selectable by the UE; and perform BFR for one or more reference signal beams, wherein the BFR for the one or more reference signal beams is performed based on the configuration information and using the selected value for each respective BFR configuration parameter of the one or more BFR configuration parameters selectable by the UE.

Aspect 2. The apparatus of Aspect 1, wherein the at least one processor is configured to determine the selected value for each respective BFR configuration parameter based on processing the radio condition information using one or more machine learning (ML) models associated with the UE.

Aspect 3. The apparatus of Aspect 2, wherein the one or more ML models are included in a scheduling engine of the UE.

Aspect 4. The apparatus of any of Aspects 1 to 3, wherein: the configuration information comprises beam failure recovery configuration information received from a network entity associated with the UE; and the one or more reference signal beams are received from the network entity.

Aspect 5. The apparatus of any of Aspects 1 to 4, wherein: the configuration information is indicative of a corresponding plurality of configured values for each respective BFR configuration parameter of the one or more BFR configuration parameters selectable by the UE; and the selected value for each respective BFR configuration parameter is determined as a selection from the corresponding plurality of configured values for each respective BFR configuration parameter.

Aspect 6. The apparatus of Aspect 5, wherein the corresponding plurality of configured values is indicated as a value range between a minimum value and a maximum value.

Aspect 7. The apparatus of any of Aspects 5 to 6, wherein the corresponding plurality of configured values is indicated as a set of indices comprising a respective index for each configured value.

Aspect 8. The apparatus of any of Aspects 1 to 7, wherein the one or more BFR configuration parameters selectable by the UE includes one or more of: a beam failure instance (BFI) maximum count parameter; a beam failure detection (BFD) timer duration parameter; or a BFR timer duration parameter.

Aspect 9. The apparatus of any of Aspects 1 to 8, wherein the one or more BFR configuration parameters selectable by the UE includes one or more of: a reference signal received power (RSRP) threshold value parameter corresponding to a beam failure detection (BFD) reference signal (BFD-RS) associated with the one or more reference signal beams; or an identifier of the beam failure detection (BFD) reference signal (BFD-RS) associated with the one or more reference signal beams.

Aspect 10. The apparatus of any of Aspects 1 to 9, wherein the one or more BFR configuration parameters selectable by the UE includes one or more of: a random access channel (RACH) configuration for candidate beam selection and beam recovery associated with the BFR by the UE; or an identifier of a candidate beam list for candidate beam selection and beam recovery associated with the BFR by the UE.

Aspect 11. The apparatus of any of Aspects 1 to 10, wherein the at least one processor is further configured to: transmit, to a network entity, reporting information indicative of the selected value determined by the UE for each respective BFR configuration parameter of the one or more BFR configuration parameters selectable by the UE.

Aspect 12. The apparatus of Aspect 11, wherein the configuration information corresponding to the BFR by the UE is received from the network entity.

Aspect 13. The apparatus of any of Aspects 11 to 12, wherein the reporting information is included in a Beam Failure Recovery Request (BFRQ) transmitted from the UE to the network entity during the BFR for the one or more reference signal beams.

Aspect 14. The apparatus of any of Aspects 11 to 13, wherein the reporting information is included in a periodic report transmitted from the UE to the network entity.

Aspect 15. The apparatus of any of Aspects 1 to 14, wherein the radio condition information is indicative of a deterioration speed associated with radio frequency (RF) communications corresponding to the UE.

Aspect 16. The apparatus of Aspect 15, wherein the configuration information is indicative of: a first BFR configuration including a first plurality of respective value ranges for the one or more BFR configuration parameters selectable by the UE, wherein the first BFR configuration corresponds to a relatively fast deterioration speed; and a second BFR configuration including a second plurality of respective value ranges for the one or more BFR configuration parameters selectable by the UE, wherein the second BFR configuration corresponds to a relatively slow deterioration speed.

Aspect 17. The apparatus of any of Aspects 15 to 16, wherein: the BFR by the UE is associated with a plurality of BFR configuration parameters; the one or more BFR configuration parameters selectable by the UE comprises a first subset of the plurality of BFR configuration parameters in response to radio condition information indicative of a relatively fast deterioration speed, wherein the first subset is indicated in the configuration information; and the one or more BFR configuration parameters selectable by the UE comprises a second subset of the plurality of BFR configuration parameters in response to radio condition information indicative of a relatively slow deterioration speed, wherein the second subset is indicated in the configuration information.

Aspect 18. A method for wireless communication by a user equipment (UE), comprising: receiving configuration information corresponding to beam failure recovery (BFR) by the UE, wherein the configuration information is indicative of one or more BFR configuration parameters selectable by the UE; determining, based on radio condition information associated with the UE, a selected value for each respective BFR configuration parameter of the one or more BFR configuration parameters selectable by the UE; and performing BFR for one or more reference signal beams, wherein the BFR for the one or more reference signal beams is performed based on the configuration information and using the selected value for each respective BFR configuration parameter of the one or more BFR configuration parameters selectable by the UE.

Aspect 19. The method of Aspect 18, further comprising determining the selected value for each respective BFR configuration parameter based on processing the radio condition information using one or more machine learning (ML) models associated with the UE.

Aspect 20. The method of Aspect 19, wherein the one or more ML models are included in a scheduling engine of the UE.

Aspect 21. The method of any of Aspects 18 to 20, wherein: the configuration information comprises beam failure recovery configuration information received from a network entity associated with the UE; and the one or more reference signal beams are received from the network entity.

Aspect 22. The method of any of Aspects 18 to 21, wherein: the configuration information is indicative of a corresponding plurality of configured values for each respective BFR configuration parameter of the one or more BFR configuration parameters selectable by the UE; and the selected value for each respective BFR configuration parameter is determined as a selection from the corresponding plurality of configured values for each respective BFR configuration parameter.

Aspect 23. The method of Aspect 22, wherein the corresponding plurality of configured values is indicated as a value range between a minimum value and a maximum value.

Aspect 24. The method of any of Aspects 22 to 23, wherein the corresponding plurality of configured values is indicated as a set of indices comprising a respective index for each configured value.

Aspect 25. The method of any of Aspects 18 to 24, wherein the one or more BFR configuration parameters selectable by the UE includes one or more of: a beam failure instance (BFI) maximum count parameter; a beam failure detection (BFD) timer duration parameter; or a BFR timer duration parameter.

Aspect 26. The method of any of Aspects 18 to 25, wherein the one or more BFR configuration parameters selectable by the ULE includes one or more of: a reference signal received power (RSRP) threshold value parameter corresponding to a beam failure detection (BFD) reference signal (BFD-RS) associated with the one or more reference signal beams; or an identifier of the beam failure detection (BFD) reference signal (BFD-RS) associated with the one or more reference signal beams.

Aspect 27. The method of any of Aspects 18 to 26, wherein the one or more BFR configuration parameters selectable by the UE includes one or more of: a random access channel (RACH) configuration for candidate beam selection and beam recovery associated with the BFR by the UE; or an identifier of a candidate beam list for candidate beam selection and beam recovery associated with the BFR by the UE.

Aspect 28. The method of any of Aspects 18 to 27, further comprising: transmitting, to a network entity, reporting information indicative of the selected value determined by the UE for each respective BFR configuration parameter of the one or more BFR configuration parameters selectable by the UE.

Aspect 29. The method of Aspect 28, wherein the configuration information corresponding to the BFR by the UE is received from the network entity.

Aspect 30. The method of any of Aspects 28 to 29, wherein the reporting information is included in a Beam Failure Recovery Request (BFRQ) transmitted from the UE to the network entity during the BFR for the one or more reference signal beams.

Aspect 31. The method of any of Aspects 28 to 30, wherein the reporting information is included in a periodic report transmitted from the UE to the network entity.

Aspect 32. The method of any of Aspects 18 to 31, wherein the radio condition information is indicative of a deterioration speed associated with radio frequency (RF) communications corresponding to the UE.

Aspect 33. The method of Aspect 32, wherein the configuration information is indicative of: a first BFR configuration including a first plurality of respective value ranges for the one or more BFR configuration parameters selectable by the UE, wherein the first BFR configuration corresponds to a relatively fast deterioration speed; and a second BFR configuration including a second plurality of respective value ranges for the one or more BFR configuration parameters selectable by the UE, wherein the second BFR configuration corresponds to a relatively slow deterioration speed.

Aspect 34. The method of any of Aspects 32 to 33, wherein: the BFR by the UE is associated with a plurality of BFR configuration parameters; the one or more BFR configuration parameters selectable by the UE comprises a first subset of the plurality of BFR configuration parameters in response to radio condition information indicative of a relatively fast deterioration speed, wherein the first subset is indicated in the configuration information; and the one or more BFR configuration parameters selectable by the UE comprises a second subset of the plurality of BFR configuration parameters in response to radio condition information indicative of a relatively slow deterioration speed, wherein the second subset is indicated in the configuration information.

Aspect 35. A method for wireless communication, comprising performing operations according to any of Aspects 18 to 34.

Aspect 36. A non-transitory computer-readable storage medium comprising instructions stored thereon which, when executed by at least one processor, causes the at least one processor to perform operations according to any of Aspects 1 to 17.

Aspect 36. A non-transitory computer-readable storage medium comprising instructions stored thereon which, when executed by at least one processor, causes the at least one processor to perform operations according to any of Aspects 18 to 34.

Aspect 37. An apparatus for wireless communication comprising one or more means for performing operations according to any of Aspects 1 to 17.

Aspect 38. An apparatus for wireless communication comprising one or more means for performing operations according to any of Aspects 18 to 34.

What is claimed is:

1. An apparatus of a user equipment (UE) for wireless communication, comprising:
at least one memory; and
at least one processor coupled to the at least one memory, wherein the at least one processor is configured to:
receive configuration information corresponding to beam failure recovery (BFR) by the UE, wherein the configuration information is indicative of one or more BFR configuration parameters selectable by the UE;
determine, based on radio condition information associated with the UE, a selected value for each respective BFR configuration parameter of the one or more BFR configuration parameters selectable by the UE; and
perform BFR for one or more reference signal beams, wherein the BFR for the one or more reference signal beams is performed based on the configuration information and using the selected value for each respective BFR configuration parameter of the one or more BFR configuration parameters selectable by the UE.

2. The apparatus of claim 1, wherein the at least one processor is configured to determine the selected value for each respective BFR configuration parameter based on processing the radio condition information using one or more machine learning (ML) models associated with the UE.

3. The apparatus of claim 2, wherein the one or more ML models are included in a scheduling engine of the UE.

4. The apparatus of claim 1, wherein:
the configuration information comprises beam failure recovery configuration information received from a network entity associated with the UE; and
the one or more reference signal beams are received from the network entity.

5. The apparatus of claim 1, wherein:
the configuration information is indicative of a corresponding plurality of configured values for each respective BFR configuration parameter of the one or more BFR configuration parameters selectable by the UE; and
the selected value for each respective BFR configuration parameter is determined as a selection from the corresponding plurality of configured values for each respective BFR configuration parameter.

6. The apparatus of claim 5, wherein the corresponding plurality of configured values is indicated as a value range between a minimum value and a maximum value.

7. The apparatus of claim 5, wherein the corresponding plurality of configured values is indicated as a set of indices comprising a respective index for each configured value.

8. The apparatus of claim 1, wherein the one or more BFR configuration parameters selectable by the UE includes one or more of:
a beam failure instance (BFI) maximum count parameter;
a beam failure detection (BFD) timer duration parameter; or
a BFR timer duration parameter.

9. The apparatus of claim 1, wherein the one or more BFR configuration parameters selectable by the UE includes one or more of:
a reference signal received power (RSRP) threshold value parameter corresponding to a beam failure detection (BFD) reference signal (BFD-RS) associated with the one or more reference signal beams; or
an identifier of the beam failure detection (BFD) reference signal (BFD-RS) associated with the one or more reference signal beams.

10. The apparatus of claim 1, wherein the one or more BFR configuration parameters selectable by the UE includes one or more of:
a random access channel (RACH) configuration for candidate beam selection and beam recovery associated with the BFR by the UE; or
an identifier of a candidate beam list for candidate beam selection and beam recovery associated with the BFR by the UE.

11. The apparatus of claim 1, wherein the at least one processor is further configured to:
transmit, to a network entity, reporting information indicative of the selected value determined by the UE for each respective BFR configuration parameter of the one or more BFR configuration parameters selectable by the UE.

12. The apparatus of claim 11, wherein the configuration information corresponding to the BFR by the UE is received from the network entity.

13. The apparatus of claim 11, wherein the reporting information is included in a Beam Failure Recovery Request (BFRQ) transmitted from the UE to the network entity during the BFR for the one or more reference signal beams.

14. The apparatus of claim 11, wherein the reporting information is included in a periodic report transmitted from the UE to the network entity.

15. The apparatus of claim 1, wherein the radio condition information is indicative of a deterioration speed associated with radio frequency (RF) communications corresponding to the UE.

16. The apparatus of claim 15, wherein the configuration information is indicative of:
a first BFR configuration including a first plurality of respective value ranges for the one or more BFR configuration parameters selectable by the UE, wherein the first BFR configuration corresponds to a relatively fast deterioration speed; and
a second BFR configuration including a second plurality of respective value ranges for the one or more BFR configuration parameters selectable by the UE, wherein the second BFR configuration corresponds to a relatively slow deterioration speed.

17. The apparatus of claim 15, wherein:
the BFR by the UE is associated with a plurality of BFR configuration parameters;
the one or more BFR configuration parameters selectable by the UE comprises a first subset of the plurality of BFR configuration parameters in response to radio condition information indicative of a relatively fast deterioration speed, wherein the first subset is indicated in the configuration information; and
the one or more BFR configuration parameters selectable by the UE comprises a second subset of the plurality of BFR configuration parameters in response to radio condition information indicative of a relatively slow deterioration speed, wherein the second subset is indicated in the configuration information.

18. A method for wireless communication by a user equipment (UE), comprising:
receiving configuration information corresponding to beam failure recovery (BFR) by the UE, wherein the configuration information is indicative of one or more BFR configuration parameters selectable by the UE;
determining, based on radio condition information associated with the UE, a selected value for each respective BFR configuration parameter of the one or more BFR configuration parameters selectable by the UE; and
performing BFR for one or more reference signal beams, wherein the BFR for the one or more reference signal beams is performed based on the configuration information and using the selected value for each respective BFR configuration parameter of the one or more BFR configuration parameters selectable by the UE.

19. The method of claim 18, further comprising determining the selected value for each respective BFR configuration parameter based on processing the radio condition information using one or more machine learning (ML) models associated with the UE, wherein the one or more ML models are included in a scheduling engine of the UE.

20. The method of claim 18, wherein:
the configuration information comprises beam failure recovery configuration information received from a network entity associated with the UE; and
the one or more reference signal beams are received from the network entity.
